(19) United States
(12) Patent Application Publication
(10) Pub. No.: US 2021/0105879 A1
(43) Pub. Date: Apr. 8, 2021

(54) LED FILAMENT LAMP WITH MULTI-PATH LED DRIVER CIRCUIT

(71) Applicants: Wenbo Ma, Shenzhen City (CN); Yu Li, Shenzhen City (CN); Qiurong Liao, Shenzhen City (CN); Chiang Li, Mei County (CN)

(72) Inventors: Wenbo Ma, Shenzhen City (CN); Yu Li, Shenzhen City (CN); Qiurong Liao, Shenzhen City (CN); Chiang Li, Mei County (CN)

(73) Assignee: GRAPHENE LIGHTING PLC, Manchester (GB)

(21) Appl. No.: 16/881,007

(22) Filed: May 22, 2020

Related U.S. Application Data
(63) Continuation-in-part of application No. 16/591,636, filed on Oct. 3, 2019, now abandoned.

(51) Int. Cl. H05B 45/38; F21V 23/00; F21V 23/02; F21K 9/238; H05B 45/345; H02M 1/14

(52) U.S. Cl. CPC H05B 45/38; F21V 23/003; F21V 23/02; F21Y 2115/10; H05B 45/345; H02M 1/14; F21K 9/238

(57) ABSTRACT

An LED filament bulb includes a driver and two filament sets. The driver includes a rectifier circuit, a filter circuit, a constant voltage (CV) circuit, a first constant current (CC) circuit and a second CC circuit. The rectifier circuit converts an AC power into a DC power. The filter circuit connects the rectifier circuit for filtering an AC component. The CV circuit connects the filter circuit for generating a fixed voltage and outputting the fixed voltage via a voltage output end. The voltage output end connects a first electrode of each filament set. The first CC circuit connects both the CV circuit and a second electrode of one of the filament sets. The second CC circuit connects both the CV circuit and a second electrode of another one of the filament sets. The CC circuits make currents flowing through the two filament sets identical.

### CROSS-REFERENCE TO RELATED APPLICATIONS

This application is a continuation-in-part of U.S. patent application Ser. No. 16/591,636 filed Oct. 3, 2019, now pending.

### TECHNICAL FIELD

The invention relates to LED (light emitting diode) lamps, particularly to LED filament lamps.

### RELATED ART

Light emitting diodes (LEDs) have widely replace conventional lighting because of high lighting luminous efficiency. There is a filament bulb in various kinds of LED lamps. Such a filament bulb possesses both shape characteristics and illuminating characteristics of incandescent bulbs, so it has become a rising product. In an LED filament bulb, multiple tiny LED chips are connected into a linear or curved shape to imitate a filament of a traditional incandescent bulb and one or more filaments are disposed in a bulb shell.

Most of LED filament bulbs adopt multiple filaments connected in parallel. There must be a difference of forward voltage (VF) between LED filaments. Complete identification of forward voltage (VF) between LED filaments is impossible. Individual bias of semiconductors always exists even if both the same material and lighting color are adopted. Parallel use of LED filaments differentiates forward currents (IF) flowing through each LED filament. A forward current flowing through an LED filament with a lower VF is higher than a forward current flowing through an LED filament with a higher VF. This is called “current hogging”. Also, because the property of VF-IF of LED, a tiny difference of forward voltage can cause a drastic variation of forward current.

The more the power of an LED filament lamp is, the more serious the influence to overall quality of a lamp due to the current hogging is. Because when power of a light source is increased, the number of LED filaments connected in parallel is correspondingly increased. The more the number of LED filaments connected in parallel is, the higher the possibility of current hogging is and the more serious the influence of current hogging is. Current hogging causes variations of intensity of LED filaments. Also, service life of an LED filament with a large forward current will be shortened because of excessive illumination.

To solve this problem, a multi-path output driver as shown in FIG. 1 is available. It integrates two or more independent driver circuits into a single circuit board. In fact, it just combines two or more driver circuits together, but it has drawbacks of high cost and large volume. Such a design can only be used in externally driving lamps (for example, LED fluorescent lamps). However, an LED filament lamp is very similar to a traditional incandescent bulb in shape, so its driver can only be received in the base (cap). A space in the base is so limited, so a conventional multi-path output driver as shown in FIG. 1 cannot be received in the base.

### SUMMARY OF THE INVENTION

An object of the invention is to provide an LED lamp with a multi-path LED driver circuit, whose volume can be effectively shrunk to be received in a base of an LED filament bulb.

To accomplish the above object, the invention provides an ELD with a multi-path LED driver circuit, which includes two sets of LED filaments and a driver circuit. The driver circuit includes a rectifier circuit, a filter circuit, a constant voltage circuit, a first constant current circuit and a second constant current circuit. The rectifier circuit connects an AC power source for converting an AC power into a DC power. The filter circuit connects the rectifier circuit for filtering an AC component. The constant voltage circuit connects the filter circuit for generating a fixed voltage and outputting the fixed voltage via a voltage output end. The voltage output end is used for connecting a first electrode of each set of LED filaments. The first constant current circuit connects both the constant voltage circuit and a second electrode of one of the two sets of LED filaments. The second constant current circuit connects both the constant voltage circuit and a second electrode of another one of the two sets of LED filaments. The first and second constant current circuits make currents flowing through the two sets of LED filaments identical.

### BRIEF DESCRIPTION OF THE DRAWINGS

FIG. 1 is a circuit diagram of a conventional multi-path LED driver;

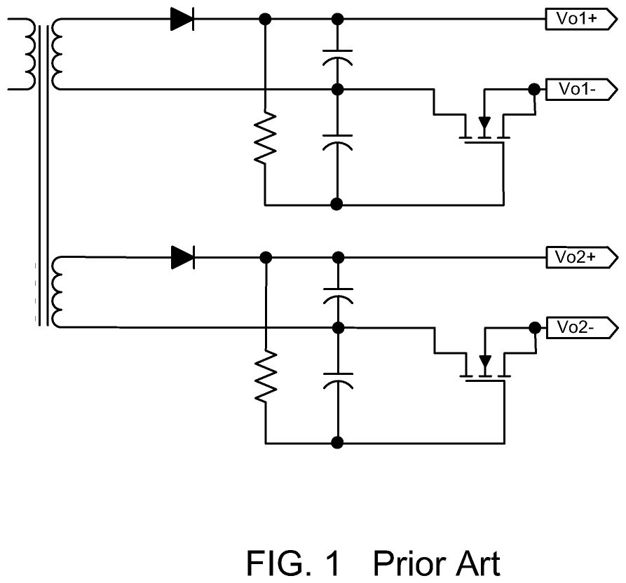

FIG. 2 is a block diagram of the driver circuit of the LED filament bulb of the invention;

FIG. 3 is a circuit diagram of the driver circuit of the LED filament bulb of the invention;

FIG. 4 is a schematic view of the LED bulb of the invention; and

FIG. 5 is a schematic view of the LED filament sets of the LED filament bulb of the invention.

### DETAILED DESCRIPTION OF THE INVENTION

In the following description, numerous specific details are set forth in order to provide a thorough understanding of various embodiments.

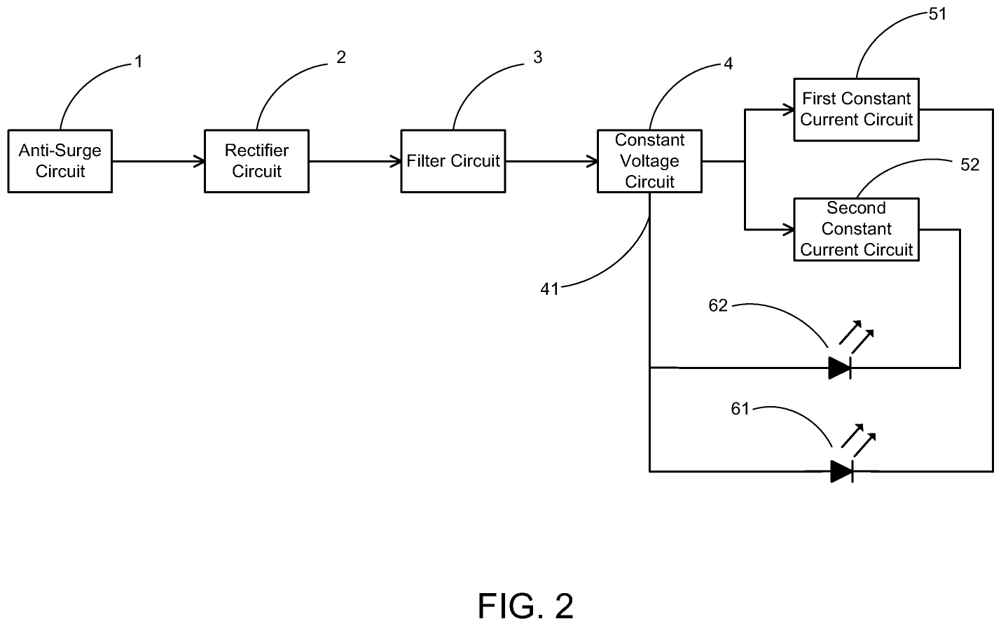

Please refer to FIG. 2. The multi-path LED driver circuit of the invention includes an anti-surge circuit 1, a rectifier circuit 2, a filter circuit 3, a constant voltage circuit 4, a first constant current circuit 51 and a second constant current circuit 52.

The anti-surge circuit 1 is a protection circuit for additionally resisting lightning strokes or voltage spikes from external alternating current (AC) power source. The anti-surge circuit 1 is not directly relative to the operation of the LED driver circuit of the invention, so it is not a necessary element. The rectifier circuit 2 is either connected to the anti-surge circuit or directly connected to an AC power source for converting AC power from the AC power source into a direct current (DC) power. The filter circuit 3 is connected to the rectifier circuit 2 for filtering an AC component (i.e. ripple) of the AC power output from the rectifier circuit 2. The constant voltage circuit 4 is connected to the filter circuit 3 for generating a fixed voltage output. The fixed voltage is output via a voltage output end 41. The voltage output end 41 is used for connecting a first electrode of each of two LEDs 61, 62 as a load. In the shown embodiment, the first electrode is a positive electrode. The first constant current circuit 51 is connected to both the constant voltage circuit 4 and a second electrode of one of the two LEDs 61, 62. The second constant current circuit 52 is connected to both the constant voltage circuit 4 and a second electrode of the other one of the two LEDs 61, 62. In the shown embodiment, the second electrode is a negative electrode. The first and second constant current circuits 51, 52 make currents flowing through the two LEDs 61, 62 identical.

The embodiment shown in the figures is just an example. And a single LED in each load path is also shown as an example. Three or more load paths may be used according to actual demands. There may be multiple LEDs connected in series and/or parallel in each load path.

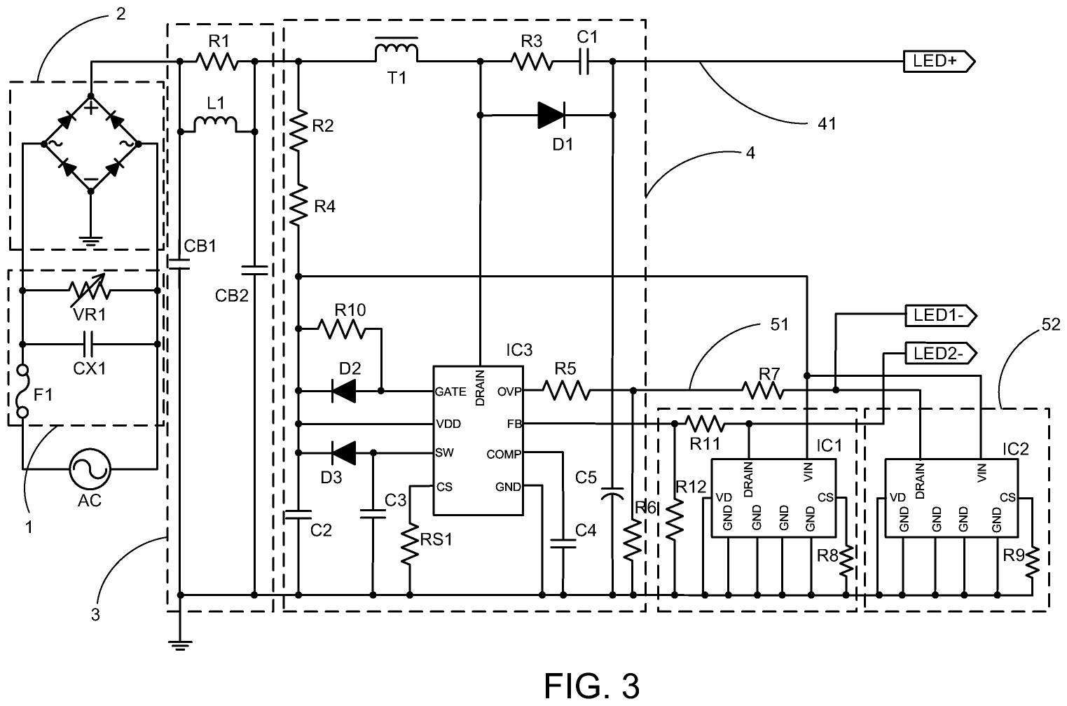

Please refer to FIG. 3. The LED driver circuit of the invention adopts the Boost framework. As shown, the constant voltage circuit 4 includes a voltage controller IC3. In this embodiment, the voltage controller IC3 adopts the BP2606D made by Bright Power Semiconductor Co., Ltd. in China. The fixed voltage is output to the first (positive) electrodes of the two load LEDs 61, 62 via a voltage output end 41. Each of the first and second constant current circuits 51, 52 forms an individual branch. Each branch includes a current controller IC1, IC2. In the shown embodiment, BP5616C made by Bright Power Semiconductor Co., Ltd. is adopted to serve as each of the current controllers IC1, IC2.

The voltage controller IC3 includes two voltage detecting pins (i.e. the OVP pin and the FB pin). The two voltage detecting pins are separately connected to high voltage interfaces of the current controllers IC1, IC2 to provide a maintenance voltage to each of the current controllers IC1, IC2. Each of the current controllers IC1, IC2 can be individually set to output a specific current. The current controllers IC1, IC2 are powered by the filter circuit 3. An output current (i.e. load current) of each branch is controlled by resistors R8 and R9 connected between the CS pin of the current controller IC1, IC2. When R8=R9, two output currents of the two branches are equal to implement current-balancing. When R8≠R9, two branches have different currents.

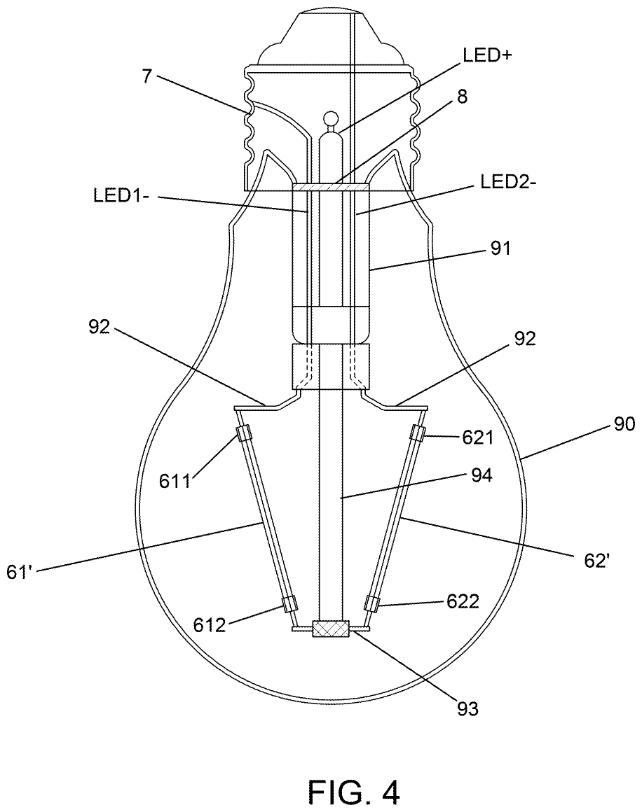

Please refer to FIG. 4. In a preferred embodiment, the LED filament lamp of the invention is of bulb type. The LED filament lamp is consisted of a base 7 and a bulb 90, the driver circuit 8 of the invention is received in the base 7. A positive electrode of a first set of LED filaments 61′ is electrically connected to the positive terminal LED+ as shown in FIG. 3, and a negative electrode thereof is electrically connected to the first negative terminal LED1−. A positive electrode of a second set of LED filaments 62′ is electrically connected to the positive terminal LED+, and a negative electrode thereof is electrically connected to the second negative terminal LED2−. Each set of LED filaments 61′, 62′ of the embodiment shown in FIG. 4 is composed of one filament. Of course, more than one filament in a single set of LED filament is also available.

A stem 91 is fixed in the bulb 90. One or more conductive members 92 are fixed onto the stem 91 for connecting the negative electrodes 611, 621 of the two sets of LED filaments 61′, 62′ to the negative terminals LED1−, LED2− of the driver circuit 8. The stem 91 is made of insulative material such as glass. A conductive support 93 connects the positive electrodes 612, 622 of the two sets of LED filaments 61′, 62′ to the positive terminals LED+ of the driver circuit 8. The conductive support 93 is supported by a pole 94 fixed on the stem 91.

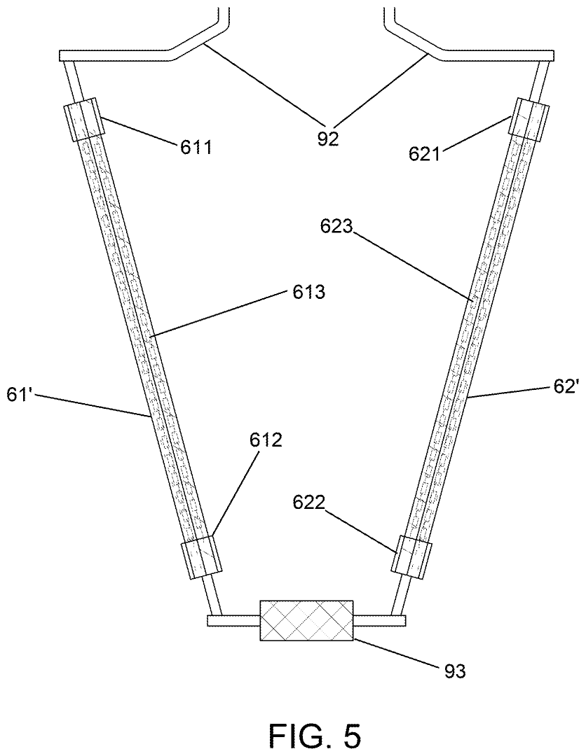

Please refer to FIG. 5, which is a partially enlarged view of FIG. 4. Each set of LED filaments 61′, 62′ includes multiple LED chips 613, 623 in series and/or in parallel. The two sets of LED filaments 61′, 62′ are connected in parallel. Each of the first set of LED filaments 61″ and the second set of LED filaments 62″ may be individually composed of multiple filaments connected in series and/or parallel, and the number of the filaments connected in series and/or parallel may be identical or different.

It will be appreciated by persons skilled in the art that the above embodiment has been described by way of example only and not in any limitative sense, and that various alterations and modifications are possible without departure from the scope of the invention as defined by the appended claims.

What is claimed is:

1. A light emitting diode (LED) lamp comprising:
two sets of LED filaments; and
a driver circuit comprising:
a rectifier circuit for connecting an alternating current (AC) power source, converting an AC power into a direct current (DC) power;
a filter circuit, connecting the rectifier circuit, and filtering an AC component in the DC power;
a constant voltage circuit, connecting the filter circuit, generating a fixed voltage, outputting the fixed voltage via a voltage output end, and the voltage output end being used for connecting a first electrode of each of the two sets of LED filaments;
a first constant current circuit, connecting both the constant voltage circuit and a second electrode of one of the two sets of LED filaments; and
a second constant current circuit, connecting both the constant voltage circuit and a second electrode of another one of the two sets of LED filaments;
wherein the first and second constant current circuits make currents flowing through the two sets of LED filaments identical.

2. The LED lamp of claim 1, wherein the first electrode is a positive electrode, and the second electrode is a negative electrode.

3. The LED lamp of claim 1, further comprising an anti-surge circuit connected between the rectifier circuit and the AC power source.

4. The LED lamp of claim 1, wherein the constant current circuit comprises a voltage controller.

5. The LED lamp of claim 4, wherein the voltage controller is an integrated circuit BP2606D.

6. The LED lamp of claim 1, wherein each of the first and second constant current circuits comprises a current controller.

7. The LED lamp of claim 6, wherein the current controller is an integrated circuit BP5616C.

8. The LED lamp of claim 6, wherein the current controllers are powered by the filter circuit.

9. The LED lamp of claim 1, further comprising a base and a bulb, wherein the driver circuit is received in the base.

10. The LED lamp of claim 9, wherein a stem is fixed in the bulb, and a conductive member is fixed onto the stem for connecting the second electrodes of the two sets of filaments to the driver circuit.

11. The LED lamp of claim 10, wherein a conductive support connects the first electrodes of the two sets of filaments to the driver circuit.

12. The LED lamp of claim 11, wherein the conductive support is supported by a pole fixed on the stem.
